(19) United States
(12) Patent Application Publication
(10) Pub. No.: US 2016/0094151 A1
(43) Pub. Date: Mar. 31, 2016

(54) POWER CONVERSION DEVICE

(71) Applicant: KABUSHIKI KAISHA TOYOTA CHUO KENKYUSHO, Nagakute-shi (JP)

(72) Inventors: Teck Chiang GOH, Nagakute-shi (JP); Takahide SUGIYAMA, Nagakute-shi (JP)

(21) Appl. No.: 14/858,738

(22) Filed: Sep. 18, 2015

(30) Foreign Application Priority Data
Sep. 25, 2014 (JP) 2014-194582

(51) Int. Cl. H02M 7/5387

(52) U.S. Cl. CPC H02M 7/53873

(57) ABSTRACT

A power conversion device includes a transformer, a first power conversion unit that performs power conversion on a primary side of the transformer to convert DC power to AC power on the primary side of the transformer, and a second power conversion unit that performs power conversion on a secondary side of the transformer to convert AC power on the secondary side of the transformer to single-phase AC power. The second power conversion unit performs the power conversion using bidirectional switching elements, and switches the bidirectional switching elements in the first power conversion unit at a zero voltage by synchronizing with switching actions in the first power conversion unit. Consequently, a loss can be lessened by making the configuration simpler.

### PRIORITY INFORMATION

The entire disclosure of Japanese Patent Application No. 2014-194582, filed on Sep. 25, 2014, including the specification, claims, drawings, and abstract, is incorporated herein by reference in its entirety.

### TECHNICAL FIELD

The present invention relates to a power conversion device that performs power conversion between DC power and single-phase AC power.

### BACKGROUND ART

JP H11-191962 A discloses a power conversion device configured to supply DC power from a DC power supply to a primary side of a transformer after changing the DC power to predetermined AC power using an inverter and to obtain DC power by rectifying AC power obtained on a secondary side of the transformer. Aforementioned JP H11-191962 A also discloses that the DC power obtained on the secondary side of the transformer is converted to AC power using an inverter.

In the power conversion device configured as above, the primary side and the secondary side are electrically isolated by the transformer and power can be transferred in two ways between the primary side and the secondary side.

Aforementioned JP H11-191962 A further discloses that an LC circuit made up of a coil and a capacitor is connected to a midpoint of a primary coil of the transformer. When configured in this manner, a primary current can be controlled without giving an influence on the secondary side of the transformer. Consequently, a power ripple (pulsation) can be lessened effectively.

In some cases, it is desirable to obtain single-phase AC power on the secondary side. The power conversion device disclosed in the aforementioned JP H11-191962 A rectifies AC power obtained on the secondary side of the transformer first and then obtains AC power using the inverter. Hence, the power conversion device requires a relatively large capacitor to smooth the rectified DC voltage. Meanwhile, there is a request for the power conversion device to reduce an energy loss to the extent possible.

### SUMMARY OF THE INVENTION

A power conversion device according to one aspect of the invention includes a transformer, a first power conversion circuit including a plurality of switching elements and configured to perform power conversion between DC power and AC power on a primary side of the transformer, a second power conversion circuit including a plurality of bidirectional switching elements and configured to perform power conversion between AC power on a secondary side of the transformer and single-phase AC power, and a control circuit configured to control switching actions of the bidirectional switching elements in the second power conversion circuit to be performed at a zero voltage by synchronizing the switching actions of the bidirectional switching elements in the second power conversion circuit to switching actions of the switching elements in the first power conversion circuit.

According to the invention, a desired AC current is obtained on the secondary side by the switching actions in the power conversion units. The need to convert the power once to DC power is thus eliminated. Also, because the zero-voltage switching is performed on the secondary side, a switching loss can be restricted.

### BRIEF DESCRIPTION OF THE DRAWINGS

FIG. 1 is a view schematically showing an overall configuration of a power conversion device according to an embodiment;

FIG. 2A is a view showing a configuration example of a bidirectional switching element;

FIG. 2B is a view showing a configuration example of a bidirectional switching element;

FIG. 2C is a view showing a configuration example of a bidirectional switching element;

FIG. 2D is a view showing a configuration example of a bidirectional switching element;

FIG. 2E is a view showing a configuration example of a bidirectional switching element;

FIG. 2F is a view showing a configuration example of a bidirectional switching element;

FIG. 3 is a view showing a configuration of a circuit that generates control signals of two power conversion units;

FIG. 4 is a view showing states of gate signal generation of the switching elements;

FIG. 5 is a view used to describe an operation of one power conversion unit;

FIG. 6 is a view showing a state of gate signal generation of the switching elements;

FIG. 7 is a view showing a state of signal generation for switching on a secondary side;

FIG. 8 is another view showing the state of signal generation for switching on the secondary side;

FIG. 9 is a view showing a logic circuit for gate signal generation of the switching elements on the secondary side;

FIG. 10 is a view showing a state of signal generation for switching on the secondary side;

FIG. 11 is a view showing a synchronized state of switching signals;

FIG. 12 is a view used to describe operations of the two power conversion units;

FIG. 13 is another view used to describe operations of the two power conversion units; and

FIG. 14 is a view showing a state of pulsation restriction on a primary side.

### DESCRIPTION OF THE EMBODIMENT

Hereinafter, an embodiment of the invention will be described by reference to the drawings. It should be appreciated, however, that the invention is not limited to the embodiment described herein.

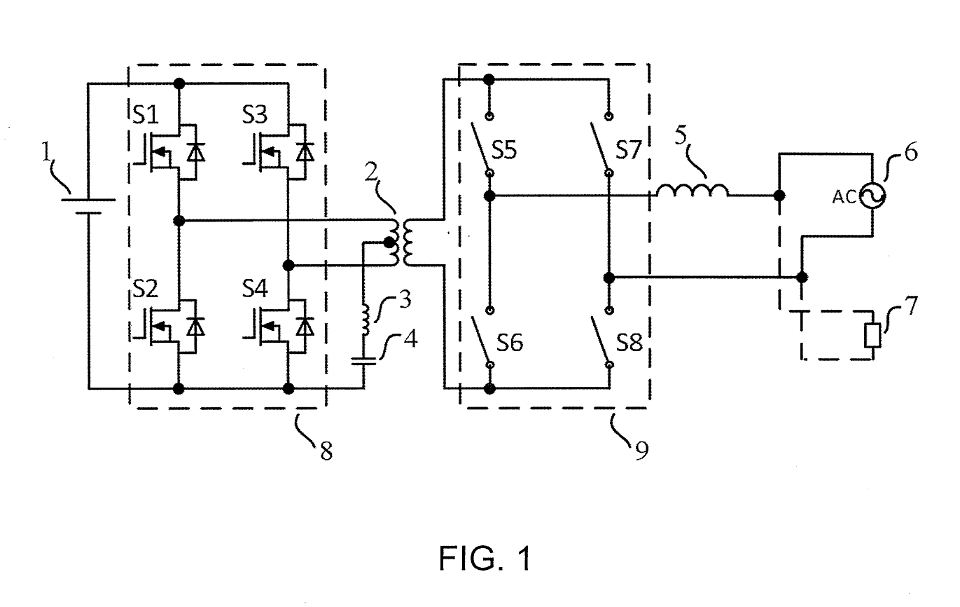

FIG. 1 is a view showing a configuration of a power conversion device according to one embodiment. In this embodiment, AC power is transferred between a primary side and a secondary side of a transformer 2 which are electrically isolated from each other. Hence, power can move in two ways. A description will be given to a case where DC power from a battery. 1, which is a DC power supply, is converted to an AC current in a power conversion unit 8 to supply the AC current to the primary side of the transformer 2 and power conversion is applied to AC power obtained on the secondary side of the transformer 2 in a power conversion unit 9 to obtain an AC power supply (AC) 6 which is the same as a commercial single-phase AC power supply (for example, at a voltage of 100 V or 200 V and a frequency of 50 Hz or 60 Hz). The AC power supply 6 can be used to drive various types of load 7 driven by a commercial power supply. When a flow of power is changed to the reverse direction, the battery 1 can be charged by using the commercial AC power supply 6 as an input.

A series connection of switching elements S1 and S2 and another series connection of switching elements S3 and S4 are connected between a positive electrode and a negative electrode of the battery 1, which is a DC power supply. Each of the switching elements S1 through S4 is formed of a parallel connection of a transistor, such as a power MOS transistor and an IGBT, and a diode that passes a current in a reverse direction to the direction in the transistor. Herein, N-type transistors are used as the switching elements S1 through S4. When the switching element is ON, the transistor passes a current from the positive electrode to the negative electrode of the battery 1 and the diode passes a current from the negative electrode to the positive electrode of the battery 1.

A midpoint of the series connection of the switching elements S1 and S2 and a midpoint of the series connection of the switching elements S3 and S4 are connected to both ends of a primary coil of the transformer 2, and the power conversion unit 8 is formed of the switching elements S1 through S4. Hence, when the switching elements S1 and S4 are switched ON, a current in one direction (a direction from top to bottom in the drawing) can be passed through (a positive voltage is generated at) the primary coil of the transformer 2. On the other hand, when the switching elements S3 and S2 are switched ON, a current in the other direction (a direction from bottom to top in the drawing) can be passed through (a negative voltage is generated at) the primary coil of the transformer 2. Hence, by alternately switching ON the switching elements S1 and S4 (switching OFF the switching elements S3 and S2) and switching ON the switching elements S3 and S2 (switching OFF the switching elements S1 and S4) repetitively, a desired AC current can be passed on the primary side of the transformer 2.

One end of a reactor 3 is connected to a center tap of the primary coil of the transformer 2 and the other end of the reactor 3 is connected to the negative electrode of the battery 1 via a capacitor 4. A current ripple (pulsation) of a primary current can be absorbed into an energy-absorbing element made up of the reactor 3 and the capacitor 4.

A series connection of switching elements S5 and S6 and another series connection of switching elements S7 and S8 are disposed to both ends of a secondary coil of the transformer 2. A midpoint of the series connection of the switching elements S5 and S6 is connected to one end of the single-phase AC power supply 6 via a reactor 5, and a midpoint of the series connection of the switching elements S7 and S8 is connected to the other end of the AC power supply 6. The AC power supply 6 outputs single-phase AC power, for example, like a commercial single-phase AC power supply, and various types of AC drive devices (the load 7) are driven by the output AC power. The power conversion device may include only the AC power supply 6 or the load 7, depending on a usage pattern. The reactor 5 may be disposed between a midpoint of the bidirectional switching elements S7 and S8 and the AC power supply 6. The reactor 5 functions as a filter and therefore a current ripple is removed. Various types of filter are available as a current ripple filter.

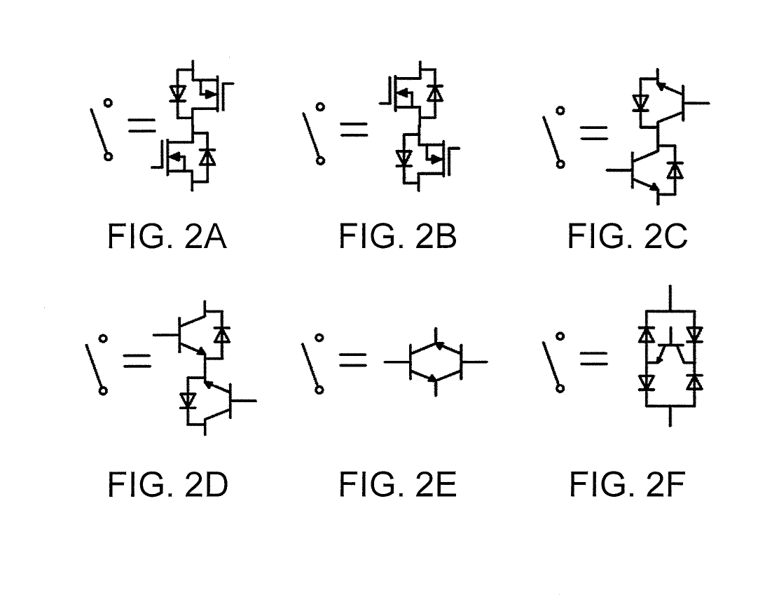

Bidirectional switching elements are adopted as the switching elements S5 through S8. For example, bidirectional switching elements shown in FIG. 2A through FIG. 2F can be adopted. In FIGS. 2A and 2B, two diodes each passing a reverse current between a source and a drain of an N-channel transistor (MOSFET) are connected in opposite directions. In FIG. 2A, by connecting a source of the lower transistor to a drain of the upper transistor, the transistors and the diodes in the two switching elements pass currents in directions opposite to each other. Hence, when the transistor in the upper switching element is switched ON, a current flows from bottom to top and when the lower transistor is switched ON, a current flows from top to bottom. In FIG. 2B, a drain of the lower transistor is connected to a source of the upper transistor. Hence, when the transistor in the upper switching element is switched ON, a current flows from top to bottom and when the lower transistor is switched ON, a current flows from bottom to top. In FIG. 2C and FIG. 2D, IGBTs are used as transistors. In FIG. 2E, two transistors are connected in directions opposite each other. Hence, when one transistor is switched ON, a current flows in one direction and when other transistor is switched ON, a current flows in the other direction. In FIG. 2F, a series connection of two diodes connected to each other at anodes and a series connection of two diodes connected to each other at cathodes are connected in parallel and midpoints of the diodes are connected with a transistor. Hence, when the transistor is switched ON, a current can be passed in either direction. Herein, a current is passed from a connection point of the cathodes to a connection point of the anodes when the transistor is switched ON. It should be noted, however, that even when the transistor is inverted, a current can be passed in two directions in the same manner by switching ON the transistor. The bidirectional switching elements S5 through S8 may adopt other configurations, so long as a current can be switched in two directions.

As has been described, the bidirectional switching elements S5 through S8 can pass a current in either direction depending on a direction in which a pair of the switching elements is switched ON. Hence, the bidirectional switching elements S5 through S8 function as a simple switch as shown in FIG. 1.

Owing to the configuration as above, by switching ON the bidirectional switching elements S5 and S8, a current flowing through the secondary coil of the transformer 2 in a direction from bottom to top of the drawing flows through the AC power supply 6 in a direction from top to bottom of the drawing, and a current flowing through the secondary coil of the transformer 2 in a direction from top to bottom of the drawing flows through the AC power supply 6 in a direction from bottom to top of the drawing.

Also, by switching ON the bidirectional switching elements S6 and S7, a current flowing through the secondary coil of the transformer 2 in a direction from bottom to top of the drawing flows through the AC power supply 6 in a direction from bottom to top of the drawing and a current flowing through the secondary coil of the transformer 2 in a direction from top to bottom of the drawing flows through the AC power supply 6 in a direction from top to bottom of the drawing.

In this manner, a current flowing through the AC power supply 6 can be controlled in an arbitrary direction independently of the direction in which the current is flowing through the secondary coil of the transformer 2.

In this embodiment, a desired AC current is supplied to the primary coil of the transformer 2 by controlling switching actions of the switching elements S1 through S4 by PWM control on the primary side, and AC power at a desired frequency (for example, 50 or 60 Hz) and a desired voltage (for example, 100V or 200V) is obtained by applying PWM control to the AC power obtained on the secondary side of the transformer 2.

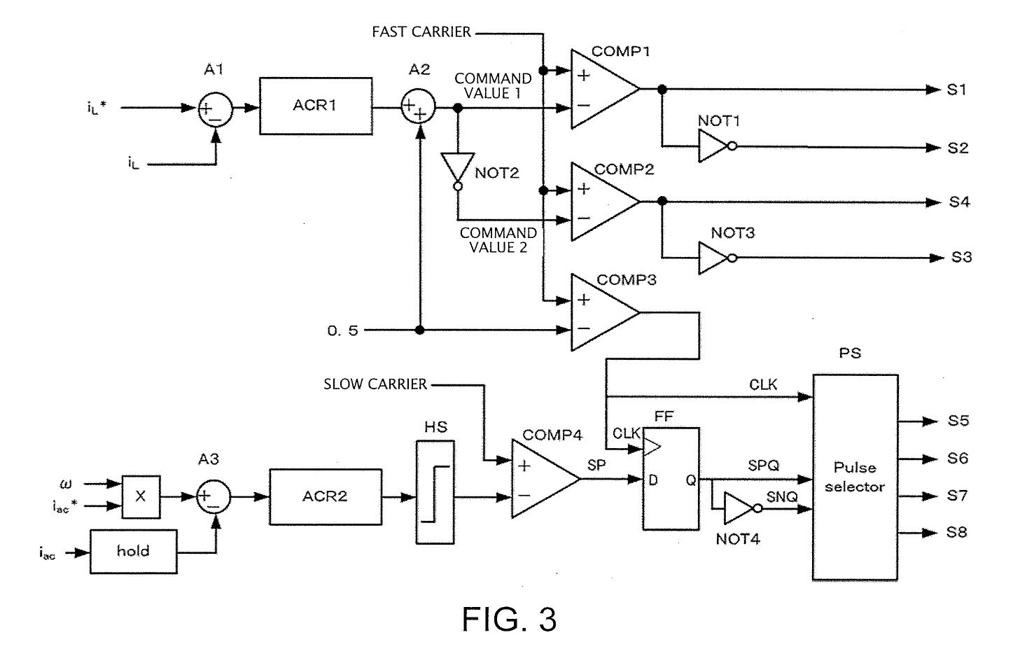

FIG. 3 shows a configuration of a control circuit to obtain PWM signals (gate signals) to control switching actions of the switching elements S1 through S8.

Firstly, a configuration to switch the switching elements S1 through S4 forming the power conversion unit 8 connected to the primary coil of the transformer 2 will be described.

A current command value iL* for the primary coil of the transformer 2 is inputted to a positive end of a subtractor A1. A current iL actually flowing through the primary coil is inputted to a negative end of the subtractor A1. Hence, an output of the subtractor A1 is a signal indicating an error from a target. The current command value iL* is, for example, an AC current value at a frequency equal to twice the frequency of the AC power supply 6, and preferably in synchronization with the AC power supply 6.

An error from the subtractor A1 is inputted into an ACR1, which is an auto current regulator and in which the input error is converted to a current command value by PI control. An output of the ACR1 is a signal centered at 0 in a range from −0.5 to +0.5. An output of the ACR1 is inputted into an adder A2, in which 0.5 is added and the output is made into a signal in a range of 0 to 1. An output of the adder A2 is inputted into a negative input terminal of a comparator COMP1. A fast carrier (for example, about 10 to 100 kHz) of a triangular wave is supplied to a positive input terminal of the comparator COMP1. Accordingly, a PWM signal is obtained at an output of the comparator COMP1. The PWM signal is used as a gate signal S1 that controls the switching element S1 to be ON or OFF. An output of the comparator COMP1 is inverted in a NOT1 and used as a gate signal S2 for the switching element S2.

Also, an output of the adder A2 is inverted in a NOT2 and inputted to a negative input terminal of a comparator COMP2. A fast carrier of a triangular wave is also supplied to a positive input terminal of the comparator COMP2 and a PWM signal (gate signal S4) for the switching element S4 is obtained at an output of the comparator COMP2. An output of the comparator COMP2 is inverted in a NOT3 and used as a PWM signal (gate signal S3) for the switching element S3.

Further, 0.5, which is a central value of a fast carrier signal, is inputted to a negative input terminal of a comparator COMP3. A fast carrier is inputted to a positive input terminal of the comparator COMP3. Hence, a PWM signal used when switching the switching elements S1 through S4 at a duty ratio of 50% is obtained at an output of the comparator COMP3. In this embodiment, this PWM signal is referred to as the synchronization signal CLK.

A configuration for switching actions in the power conversion unit 9 connected to the secondary coil of the transformer 2 will now be described.

Firstly, a current command iac* as a target of the AC power supply 6 and a detected current phase ω are inputted into a multiplier X to obtain a current command value of a sine wave at 50 or 60 Hz by adjusting a phase of the current command iac*. The obtained current command value is inputted to a positive input terminal of a subtractor A3. An actual current iac of the AC power supply 6 is inputted to a negative input terminal of the subtractor A3 via a hold circuit hold. The hold circuit hold is a zero-order hold circuit that holds an input signal of one sampling cycle. The current command iac* is equal to an AC current by an AC power supply at, for example, 50 Hz and 100 V.

In the subtractor A3, an error between the current command value obtained from the current command iac*, which is the target value of the AC power supply 6, and the actual current iac is calculated, and the calculated error is inputted into an ACR2. The ACR2 determines an actual current command value by the PI control and supplies the determined current command value to a hysteresis circuit HS. The hysteresis circuit HS outputs a plus constant value when the inputted current command value (input command value) is a positive value and outputs 0 when the input command value increases to a pre-set upper-limit value. The hysteresis circuit HS changes an output of 0 to a positive constant value when the input command value decreases to a pre-set lower-limit value.

An output (command value) of the hysteresis circuit HS is inputted to a negative input terminal of a comparator COMP4 and a slow carrier is inputted to a positive input terminal of the comparator COMP4. Hence, a signal SP that shifts to an H level when the slow carrier exceeds the command value is obtained at an output of the comparator COMP4.

The signal SP from the comparator COMP4 is inputted to a D-input terminal of a flip-flop FF. A clock input terminal CLK of the flip-flop FF is supplied with the synchronization signal CLK, which is an output of the comparator COMP3 described above. Hence, the flip-flop FF takes an output of the hysteresis circuit HS at a rising timing of the synchronization signal CLK and outputs the taken output to an output Q.

The output Q (signal SPQ) of the flip-flop FF is inputted into a pulse selector PS. The pulse selector PS is also supplied with the synchronization signal CLK described above and a signal SNQ which is the signal SPQ inverted in a NOT4. The pulse selector SP generates gate signals S5 through S8 to switch the switching elements S5 through S8 by combining the input signals CLK, SPQ, and SNQ. The four gate signals S5 through S8 are supplied to the switching elements S5 through S8, respectively, and switching actions of each are controlled.

### Switching of Switching Elements

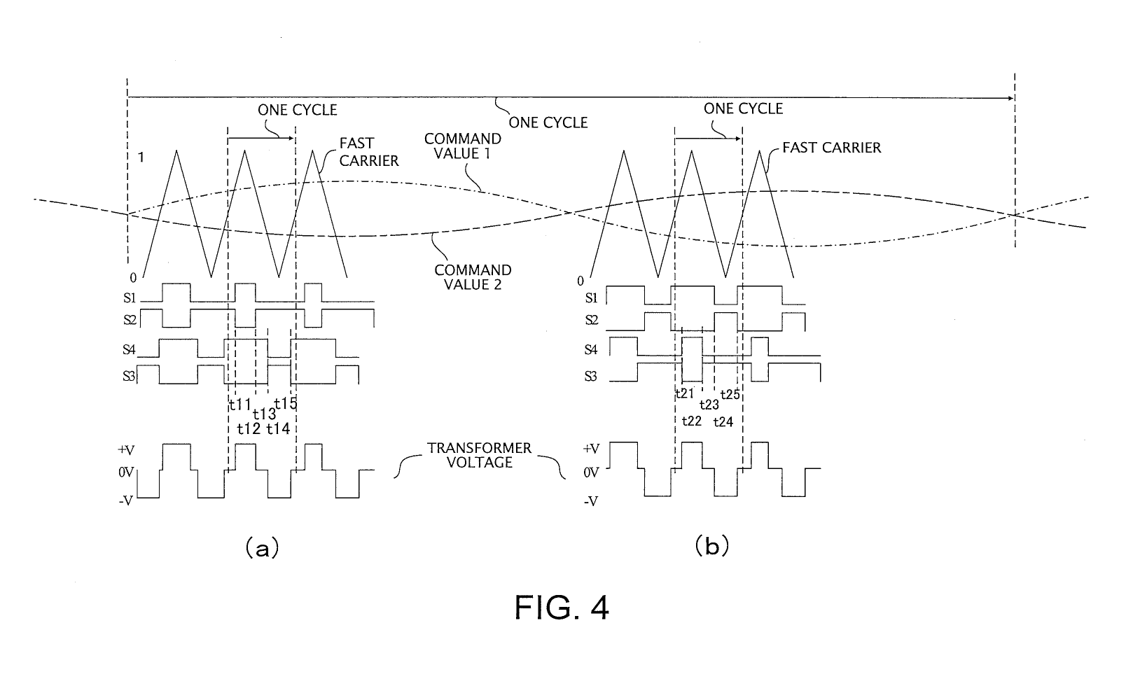

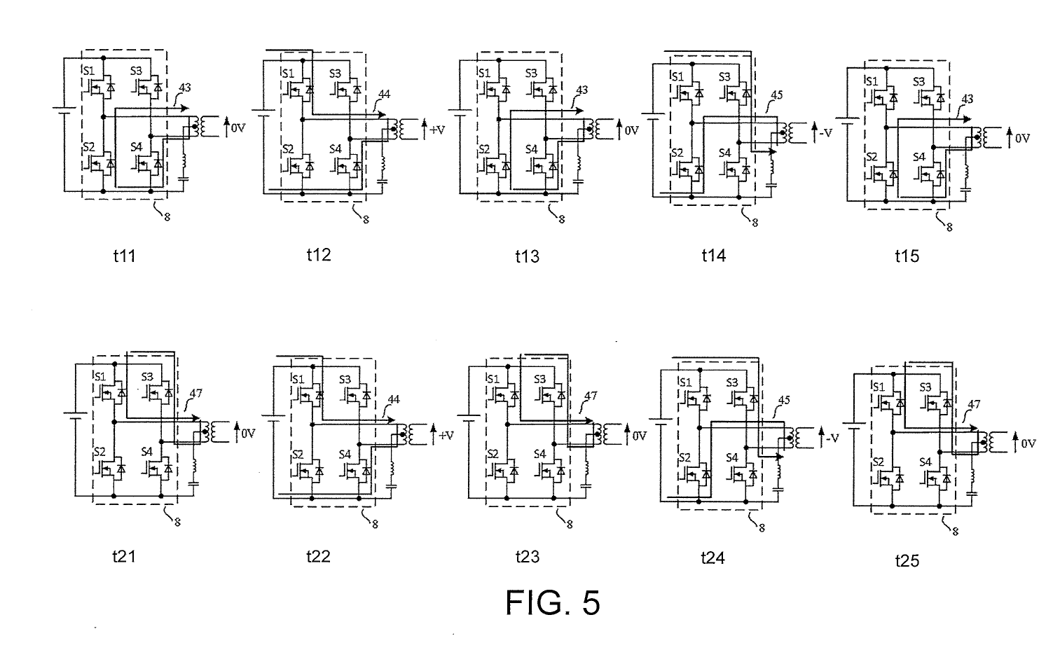

The switching elements S1 through S4 will now be described by reference to FIGS. 4A and 4B and FIG. 5. PWM signals (gate signals) to control the switching actions of the switching elements S1 through S8 are also denoted as S1 through S8, respectively.

An output from the adder A2 is an AC signal centered at 0.5. A phase of the AC signal is inverted and resulting command value 1 and command value 2 are inputted into the comparators COMP1 and COMP2, respectively, in which the command values 1 and 2, respectively, are compared with a fast carrier (triangular wave) that varies between 0 and 1. The gate signals S1 through S4 are obtained from comparison results and the gate signals S1 through S4 are supplied to the switching elements S1 through S4, respectively. When the gate signals S1 through S4 are at the H level, the switching elements S1 through S4 are ON.

The command value 1 inputted into the comparator COMP1 and the command value 2 inputted into the comparator COMP2 are anti-phase. The comparators COMP1 and COMP2 respectively compare the command values 1 and 2 with a fast carrier. Hence, the gate signals S1 and S3 are obtained at the outputs of the comparators COMP1 and COMP2, respectively. The gate signals S2 and S4 are obtained by inverting the gate signals S1 and S3, respectively.

FIGS. 4A and 4B show one cycle of the command values 1 and 2 and a part of the fast carrier. The command values 1 and 2 are an increasing and decreasing sine wave centered at 0.5. The fast carrier is a triangular wave varying between 0 and 1. A frequency of the command values 1 and 2 is set to twice the frequency of the AC power supply 6.

FIG. 4 shows the gate signals S1 through S4 (first half) when the command value 1 is positive (0.5 or greater) and the command value 2 is negative (0.5 or less). As shown in FIG. 4, S1 shifts to the H level when the fast carrier is greater than the command value 1 and S2 is an inverted signal of S1. Also, S4 shifts to the H level when the fast carrier is greater than the command value 2 and S3 is an inverted signal of S4. In the case of FIG. 4, an H-level period of S1 (ON period of the switching element S1) is shorter than an ON period of S4 and an ON period of S3 is shorter than an ON period of S2.

The gate signals S1 through S4 are all synchronized signals. The S1 and S2 are anti-phase and the S3 and S4 are anti-phase. Duty ratios of S1 and S3 are the same and duty ratios of S2 and S4 are the same.

FIG. 5 (upper row) shows currents flowing through the primary coil of the transformer 2 during five periods t11 through t15 in one cycle of the fast carrier in FIG. 4. FIG. 4 also shows a secondary voltage (transformer voltage) of the transformer 2.

In t11, S2 and S4 are switched ON and both ends of the transformer 2 are connected to the negative electrode of the battery 1. Hence, no current flows fundamentally and the secondary voltage is 0 V. At a stage before S4 is switched ON, S3 is ON and the lower side of the primary coil has a high voltage. Hence, during t11, a current 43 flows from the lower side of the primary coil to the upper side of the primary coil via the diodes in S4 and S2. It should be noted, however, that the secondary voltage (transformer voltage) is a zero voltage (0 V).

In t12, S1 and S4 are switched ON and a current 44 flows through the transformer 2 from top to bottom of the drawing and the secondary voltage of the transformer 2 becomes a positive voltage (+V). In t13, S2 and S4 are switched ON and the secondary voltage becomes 0 V. In t14, S3 and S2 are switched ON and a current 45 flows through the transformer 2 from top to bottom of the drawing and the secondary voltage of the transformer 2 becomes a negative voltage (−V). In t15, S2 and S4 are switched ON and the secondary voltage of the transformer 2 becomes 0 V. During t13 and t15, a circulation current that corresponds to an AC current flowing through the secondary coil flows through the primary coil of the transformer 2.

In this manner, a voltage repetitively varying from 0 V to +V to 0 V to −V to 0 V is generated on the secondary side of the transformer 2.

FIG. 4 shows the gate signals S1 through S4 (second half) when the command value 1 is negative (0.5 or less) and the command value 2 is positive (0.5 or greater). In this phase, ON periods of S1 and S3 are longer than ON periods of S2 and S4, respectively. Hence, as shown in FIG. 5 (lower row), S1 and S3 are switched ON in t21, t23, and t25 and both ends of the primary coil of the transformer 2 are connected to the power supply side (positive electrode of the battery 1). Although a current 47 flows, a current through the primary coil stops and a voltage across the secondary coil becomes 0 V. In t22, S1 and S4 are switched ON. Hence, the current 44 from top to bottom flows through the primary coil and a positive voltage (+V) is generated at the secondary coil. In t24, S3 and S2 are switched ON and the current 45 from bottom to top flows through the primary coil. Hence, a negative voltage (−V) is generated at the secondary coil.

In this manner, a voltage repetitively varying from 0 V to +V to 0 V to −V to 0 V is generated on the secondary side of the transformer 2.

In the cases of FIGS. 4A and 4B, t11 through t15 (t21 through t25) are one cycle of the fast carrier and t15 and t11 are the same time point in one cycle of the fast carrier. Hence, a zero voltage period in which a voltage at the secondary coil of the transformer 2 becomes 0 V occurs twice.

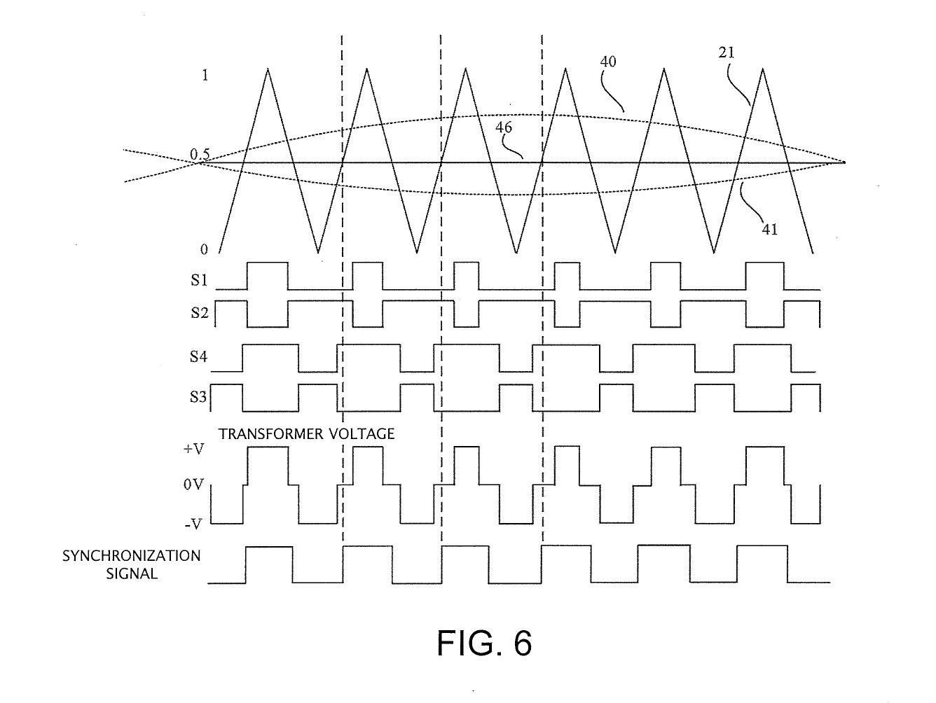

FIG. 6 is a view corresponding to FIGS. 4A and 4B. The synchronization signal CLK obtained in the comparator COMP3 of FIG. 3 crosses 0.5 of the fast carrier at rising. The rising of the synchronization signal CLK corresponds to the zero voltage period of the transformer voltage.

### Current Command on Secondary Side

On the secondary side of the transformer 2, an AC current at 50 Hz or 60 Hz as high as the frequency of the AC power supply is generated by controlling ON and OFF actions of the bidirectional switching elements S5 through S8.

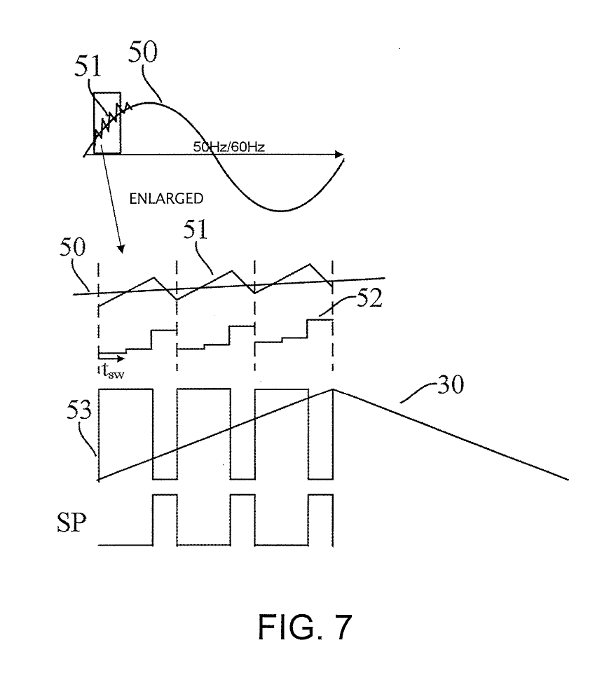

FIG. 7 shows a current command to control the bidirectional switching elements S5 through S8 to be ON or OFF.

A current phase and a voltage phase are adjusted in the multiplier X to generate a current command value 50 as high as the frequency of the current power supply 6. Meanwhile, a detected actual AC current iac (current 51) of the AC power supply 6 is held at an interval tsw in the 0-degree hold circuit hold, and outputted as a current value 52 from the 0-degree hold circuit hold. The interval tsw is a switching cycle of the switching side S5 through S8.

A difference between the current value 52 and the current command value 50 is calculated in the subtractor A3, and a ratio signal 53 is obtained by way of the hysteresis circuit HS. The ratio signal 53 is compared with a slow carrier 30 (for example, 10 kHz) in the comparator COMP4. A signal SP that stays at the H level in a period during which the slow carrier is greater than the ratio signal 53 is obtained at the output of the comparator COMP4. The signal SP corresponds to a PWM signal based on an error current. The switching elements S5 through S8 may be controlled according to the signal SP. In such a case, however, switching timing of the switching elements S5 through S8 becomes out of synchronization with the secondary current of the transformer 2 and a switching loss is increased.

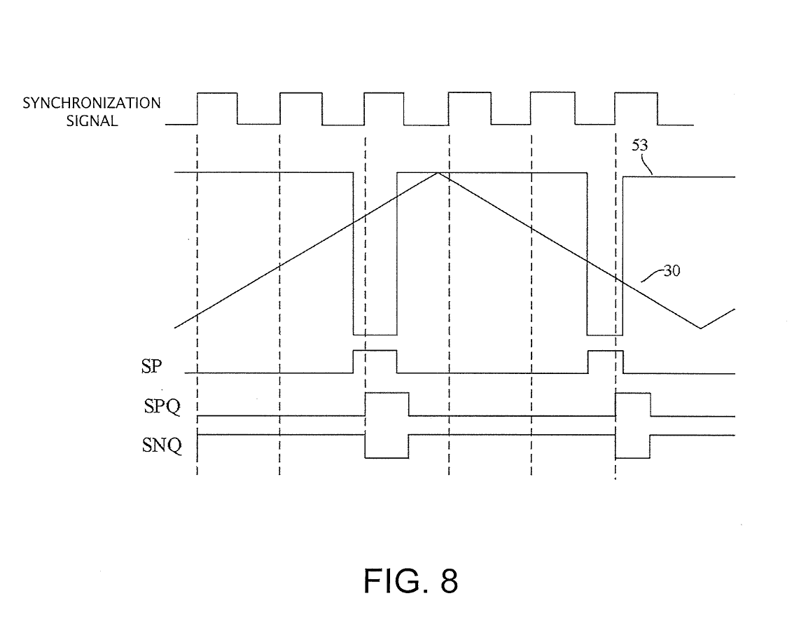

The signal SP is inputted to the D-input terminal of the flip-flop FF and taken into the flip-flop FF at the rising of the synchronization signal CLK. Accordingly, a signal SPQ that rises at the rising of the synchronization signal CLK as shown in FIG. 8 is obtained. The signal SPQ is inverted in the NOT4 and a signal SNQ is obtained.

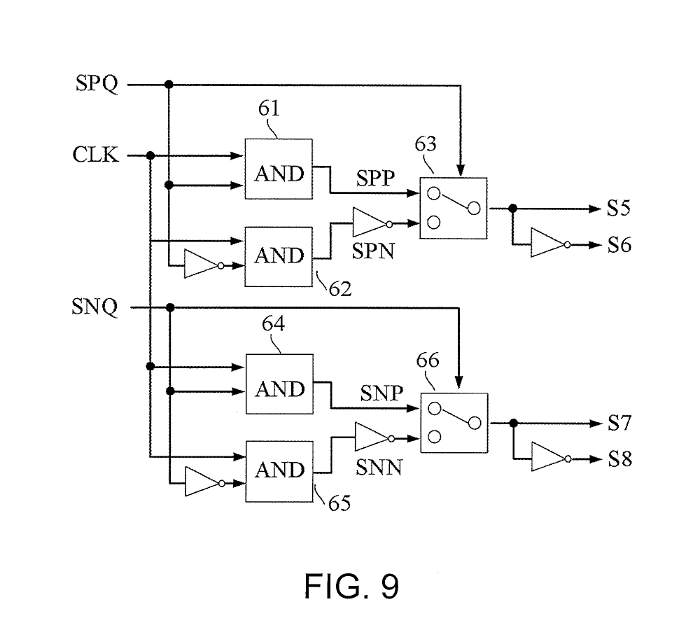

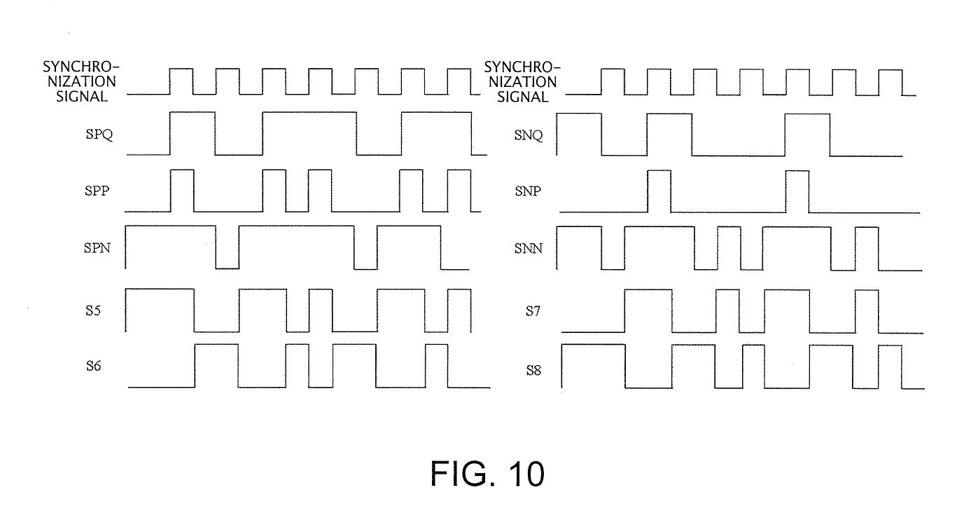

The signals SPQ and SNQ obtained in this manner are supplied to the pulse selector PS, which is a logic circuit and in which the gate signals S5 through S8 are generated by logical operations. FIG. 9 shows logic of the pulse selector PS. FIG. 10 shows states of the respective signals.

In other words, the secondary voltage (transformer voltage) of the transformer 2 inverts with the synchronization signal CLK. On the other hand, an AC current of the AC power supply 6 is at 50 or 60 Hz, which is totally different from the frequency of the transformer voltage. Hence, in order to obtain an AC current of the AC power supply 6 from the transformer voltage, a state in which the switching elements S5 and S8 are switched ON and a state in which the switching elements S7 and S6 are switched ON are switched with the synchronization signal CLK. Consequently, power conversion is applied to the secondary current of the transformer 2 and a current corresponding to the AC current command iac* is obtained.

The signal SPQ is inputted into an AND logic 61 intact and into an AND logic 62 inverted. The synchronization signal CLK is also inputted into the AND logics 61 and 62. Hence, the AND logics 61 and 62 find ANDs of the signal SPQ and inverted signal SPQ, respectively, and the synchronization signal CLK. Consequently, the synchronization signal CLK in an H-level period of the signal SPQ is made into a signal SPP and an output of the synchronization signal CLK in an L-level period of the signal SPQ is inverted and made into a signal SPN.

The output signal SPP of the AND logic 61 and the signal SPN which is an inverted output of the AND logic 62 are supplied to a selector 63, in which either the signal SPP or SPN is selected. The selector 63 selects the signal SPP when the signal SPQ is at the H level and the signal SPN at the L level. An output of the selector 63 is made into the gate signal S5 and an inverted output of the selector 63 is made into the gate signal S6.

A generation circuit of the gate signals S7 and S8 is the same as the generation circuit of the gate signals S5 and S6, and has two AND logics 64 and 65 and one selector 66. A signal SNQ and the synchronization signal CLK are inputted into the AND logic 64 and an inverted signal of the signal SNQ and the synchronization signal CLK are inputted into the AND logic 65. An output SNP of the AND logic 64 and an inverted output SNN of the AND logic 65 are inputted into the selector 66, in which either the output SNP or SNN is selected according to the signal SNQ. An output of the selector 66 is made into the gate signal S7 and an inverted output is made into the gate signal S8.

The switching signals S5 through S8 are obtained in this manner. The switching signals S5 and S8 are the same signal and so are the switching signals S6 and S7. It is not necessary to generate the same signals in parallel.

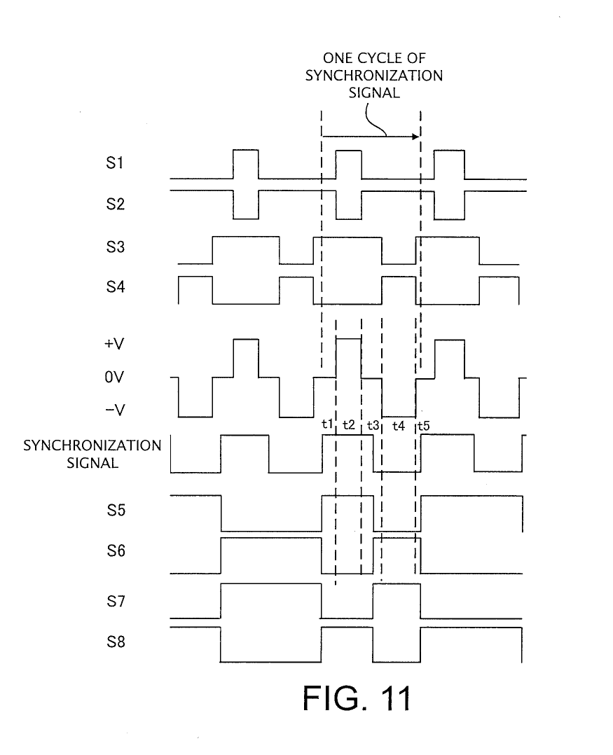

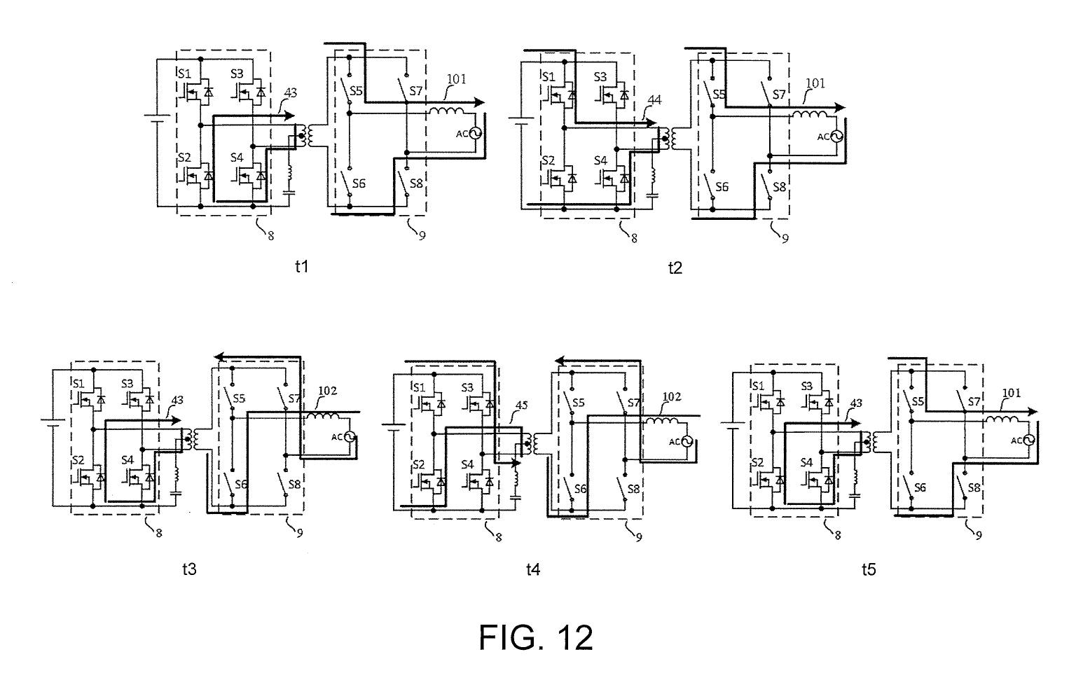

FIG. 11 shows switching timings of the respective switching elements S1 through S8. FIG. 12 shows zero-voltage (0 V) switching operations of the power conversion units 8 and 9 at the timings in t1 through t5 (each timing in one cycle of the synchronization signal).

In t1, the switching elements S2 and S4 are switched ON to short-circuit both ends of the primary coil of the transformer 2. Accordingly, the current 43 circulates and a zero voltage is generated on the secondary side of the transformer 2. On the secondary side, the switching elements S5 and S8 are switched ON and a current 101 flows continuously from the previous state.

In t2, the switching elements S1 and S4 are switched ON and the switching elements S2 and S3 are switched OFF. Accordingly, the current 44 flows on the primary side of the transformer 2 and a positive voltage is generated on the secondary side of the transformer 2. The switching elements S5 and S8 on the secondary side are held ON. The current 101 corresponding to the transformer voltage generated on the secondary side of the transformer 2 thus flows.

In t3, the switching elements S2 and S4 are switched ON. Accordingly, the current 43 circulates on the primary side and a zero voltage is generated on the secondary side of the transformer 2. In this period, the zero-voltage switching is performed in the power conversion unit 9 to switch OFF the switching elements S5 and S8 and switch ON the switching elements S6 and S7. A current 102 thus flows. In this manner, a voltage on the secondary side of the transformer 2 inverts. However, a direction of the current through the AC power supply 6 remains unchanged.

In t4, the switching element S3 is switched ON while the switching element S2 is held ON. Accordingly, the current 45 flows and a negative voltage is generated on the secondary side of the transformer 2. On the secondary side, the current 102 continues to flow because the switching elements S6 and S7 are held ON.

In t5, the switching elements S2 and S4 are switched ON and a zero voltage is generated on the secondary side of the transformer 2. In this period, the switching elements S6 and S7 are switched OFF and the switching elements S5 and S8 are switched ON. The current 101 thus flows. ON and OFF timings of the switching elements on the secondary side are the timings at which the transformer voltage becomes a zero voltage.

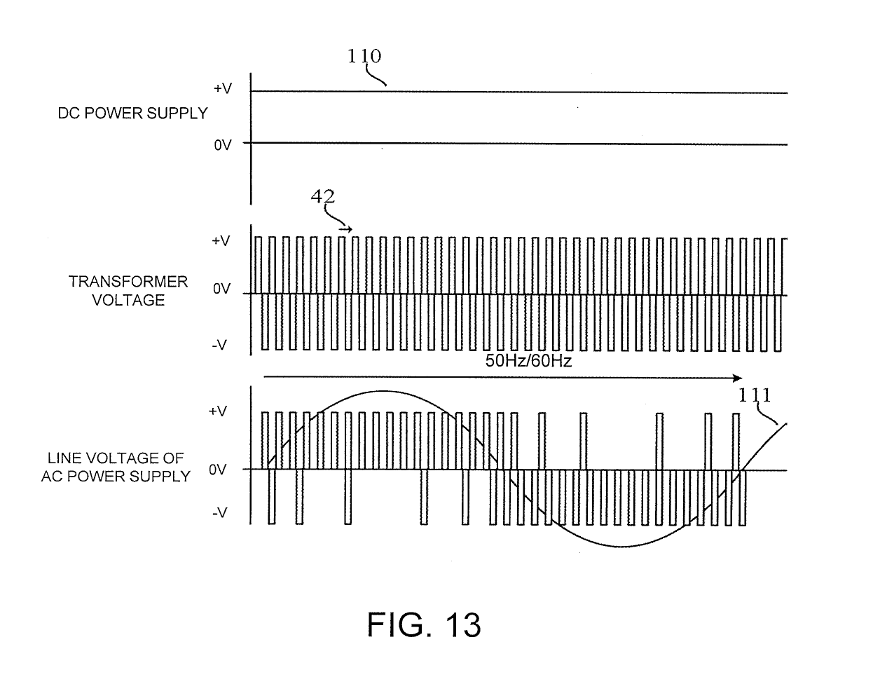

FIG. 13 shows waveforms of the DC power supply and the AC power supply in this embodiment. The power conversion unit 8 converts the DC voltage 110 to a high-frequency transformer voltage that repetitively alternates between positive and negative values with the fast carrier. The power conversion unit converts the high-frequency transformer voltage to a low-frequency AC voltage to form a sine-wave voltage 111.

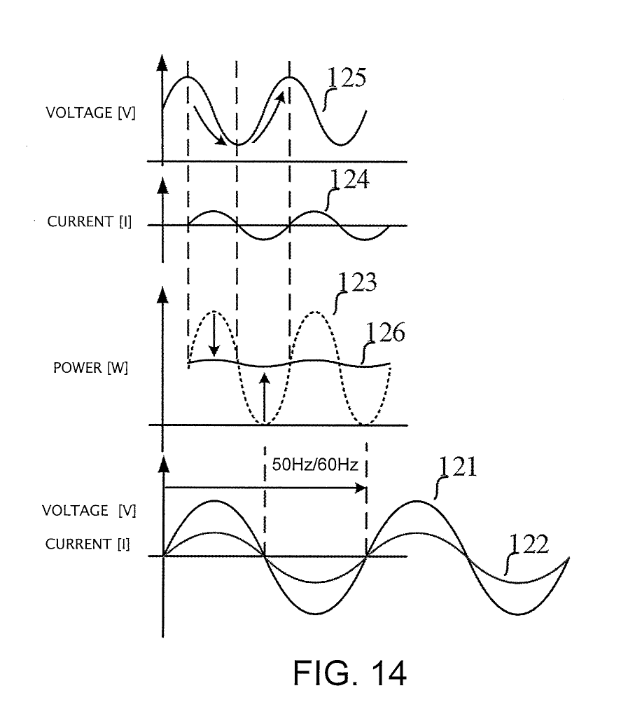

FIG. 14 shows an operation to restrict single-phase AC power pulsation. In FIG. 14, a voltage 125 represents a voltage across the capacitor 4 on the primary side of the transformer 2. As shown in FIG. 14, the voltage varies with application of a voltage to the primary side of the transformer 2. The frequency is a frequency of the AC command value (command values 1 and 2) of FIG. 4 equal to twice the frequency of the AC power supply 6. A current 124 is a current through the reactor 3 and has a 90°-phase shift from the voltage 125.

On the other hand, an AC voltage 121 and an AC current 122 of the AC power supply 6 are generated on the secondary side of the transformer 2. Hence, pulsation corresponding to this single-phase AC power (power as the product of the AC voltage 121 and the AC current 122) is also transferred to the primary side of the transformer 2.

Hence, pulsating power 123 is generated on the primary side and applied to the battery 1.

In this embodiment, the transformer 2 has the buffer circuit made up of the series connection of the reactor 3 and capacitor 4 at the center tap. On the secondary side of the transformer 2, a voltage and a current at a frequency (for example, 50 Hz) corresponding to the AC power supply 6 are generated. However, because the generated voltage and current are a single-phase AC, the generated voltage and current as power pulsates at twice the frequency (for example, 100 Hz). On the other hand, the battery 1 is the DC power supply, and pulsation at the same frequency is generated as a battery current when the battery 1 is used intact. In this embodiment, by controlling the switching actions of the switching elements S1 through S4, amplitude and a phase of the current flowing through the reactor 3 are controlled and the capacitor 4 is charged and discharged with the controlled current.

In particular, when AC power pulsation (for example, 100 Hz) is generated on the secondary side of the transformer 2, the capacitor 4 is charged and discharged. Hence, power corresponding to the secondary power can be supplied to the primary side. Accordingly, power can be supplied to the secondary side by using the current with which the capacitor 4 is charged and discharged instead of using the current from the battery 1. In other words, by charging and discharging the capacitor 4 with the current in phase with the secondary AC power pulsation, pulsation of the battery current can be lessened.

1. A power conversion device, comprising:
a transformer;
a first power conversion circuit comprising a plurality of switching elements, the first power conversion circuit performing power conversion between DC power and AC power on a primary side of the transformer;
a second power conversion circuit comprising a plurality of bidirectional switching elements, the second power conversion circuit performing power conversion between AC power on a secondary side of the transformer and single-phase AC power; and
a control circuit configured to control switching actions of the bidirectional switching elements in the second power conversion circuit to be performed at a zero voltage by synchronizing the switching actions of the bidirectional switching elements in the second power conversion circuit to switching actions of the switching elements in the first power conversion circuit.

2. The power conversion device according to claim 1, wherein:
the control circuit synchronizes gate signals to control the switching actions of the switching elements forming the first power conversion unit and gate signals to control the bidirectional switching elements with each other.

3. The power conversion device according to claim 2, wherein:
the control circuit comprises a logic circuit, and
the gate signals are synchronized with each other by the logic circuit.

4. The power conversion device according to claim 2, wherein:
the control circuit controls switching actions of the plurality of bidirectional switching elements, and
the second power conversion circuit converts AC power on the secondary side of the transformer to a single-phase AC power at a lower frequency.

5. The power conversion device according to claim 3, wherein:
the control circuit controls switching actions of the plurality of bidirectional switching elements, and
the second power conversion circuit converts AC power on the secondary side of the transformer to a single-phase AC power at a lower frequency.
